(19) United States
(12) Patent Application Publication
(10) Pub. No.: US 2017/0234715 A1
(43) Pub. Date: Aug. 17, 2017

(54) SENSOR SYSTEMS AND METHODS

(71) Applicant: Simmonds Precisin Products, Inc., Vergennes, VT (US)

(72) Inventors: Rollin W. Brown, South Burlington, VT (US); Mark Bellinger, Cornwall, VT (US)

(21) Appl. No.: 15/423,963

(22) Filed: Feb. 3, 2017

Related U.S. Application Data
(60) Provisional application No. 62/295,289, filed on Feb. 15, 2016.

(51) Int. Cl. G01F 23/00; G01F 23/24; G01F 23/26; H04Q 9/00

(52) U.S. Cl. CPC G01F 23/0076; H04Q 9/00; G01F 23/24; G01F 23/26; H04Q 2209/88; H04Q 2209/40

(57) ABSTRACT

A sensor system includes a sensor operatively connected to a liquid storage vessel. An electronics unit is operatively connected to the sensor. The electronics unit includes a power source for providing electrical excitation to the sensor. An antenna is operatively connected to the electronics unit to receive data there from and to provide power to the power source. The antenna is wirelessly connected to a remote processing unit to transmit data thereto and to receive power there from.

### CROSS-REFERENCE TO RELATED APPLICATIONS

The subject application claims the benefit of priority from U.S. Provisional Patent Application Ser. No. 62/295,289 filed Feb. 15, 2016, the disclosure of which is herein incorporated by reference in its entirety.

### BACKGROUND OF THE INVENTION

1. Field of the Invention

The present invention relates to sensor systems, in particular to fuel sensor systems.

2. Description of Related Art

Traditional fuel sensor systems may use liquid height sensors, densitometers, and other sensor probes to determine height and overall quantity of fuel in the fuel storage. Additionally, other fuel properties, such as temperature, can also be measured. In some measurement applications, for instance, knowledge of fuel level and quantity is needed to support, for example, automatic shutoff during refueling, independent low level warnings, and/or transfers between fuel storage vessels.

Such conventional methods and systems have generally been considered satisfactory for their intended purpose. However, there is still a need in the art for systems and methods that allow for improved fuel sensing systems, for example, systems in flammable environments. The present invention provides a solution for these problems.

### SUMMARY OF THE INVENTION

A sensor system includes a sensor operatively connected to a liquid storage vessel. An electronics unit is operatively connected to the sensor. The electronics unit includes a power source for providing electrical excitation to the sensor. An antenna is operatively connected to the electronics unit to receive data there from and to provide power to the power source. The antenna is wirelessly connected to a remote processing unit to transmit data thereto and to receive power there from.

In accordance with some embodiments, the sensor is at least partially disposed in the liquid storage vessel and exposed to liquid. The sensor can be an inductance sensor, e.g. a densitometer, a resistance sensor, e.g. a temperature sensor, and/or a capacitance sensor, e.g. a fluid height sensor. The sensor can be one of a plurality of sensors, wherein the plurality of sensors can include at least one of an inductance sensor, a capacitance sensor, or a resistance sensor. The antenna can be configured to be at least partially outside of the liquid vessel. The remote processing unit can be operatively connected to one or more additional antennas configured to transmit and receive wireless signals to and from the antenna. The remote processing unit can be located at least partially disposed outside of the liquid storage vessel or within the vehicle such that the antennas are within the fluid vessel with the electronics. The system can include an optical cable connecting the electronics unit to the sensor to transmit power to the sensor and data from the sensor to the electronics unit. The power source can include a battery operatively connected to the antenna to store power received from the antenna.

In accordance with another aspect, a method for sensing characteristics of a liquid in a liquid storage vessel includes providing electrical power to an electronics unit through an antenna. The electronics unit is operatively connected to a sensor. The method includes transmitting data from the sensor to the electronics unit. The method includes wirelessly transmitting the data from the electronics unit to a remote processing unit with the antenna. The antenna is at least partially disposed outside of a liquid storage vessel.

It is contemplated that the data can include at least one of a height, a density, or a temperature of the liquid. The sensor can be one of a plurality of sensors in a sensor network. The sensor network can include at least one of a height sensor, a densitometer or a temperature sensor. The method can include transmitting and receiving wireless signals to and from the antenna with at least one additional antenna operatively connected to the remote processing unit. The method can include transmitting power with an optical cable from the electronics unit to the sensor, and can include storing power received from the antenna in a battery in the electronics unit. The method can include determining a liquid quantity in the liquid storage vessel based on the data transmitted to the remote processing unit. The data can include at least one of a height, a density, or a temperature of the liquid.

These and other features of the systems and methods of the subject invention will become more readily apparent to those skilled in the art from the following detailed description of the preferred embodiments taken in conjunction with the drawings.

### BRIEF DESCRIPTION OF THE DRAWINGS

So that those skilled in the art to which the subject invention appertains will readily understand how to make and use the devices and methods of the subject invention without undue experimentation, preferred embodiments thereof will be described in detail herein below with reference to certain figures, wherein:

FIG. 1 is a schematic depiction of a sensor system constructed in accordance with an embodiment the present disclosure;

FIG. 2 is a flow chart schematically depicting a method for sensing characteristics of a liquid in a liquid storage vessel using the sensor system of FIG. 1 in accordance with an embodiment of the present disclosure; and

FIG. 3 is a schematic depiction of another embodiment of a sensor system constructed in accordance with an embodiment of the present disclosure, showing the electronics unit with antennas that penetrate directly into the liquid storage vessel.

### DETAILED DESCRIPTION OF THE PREFERRED EMBODIMENTS

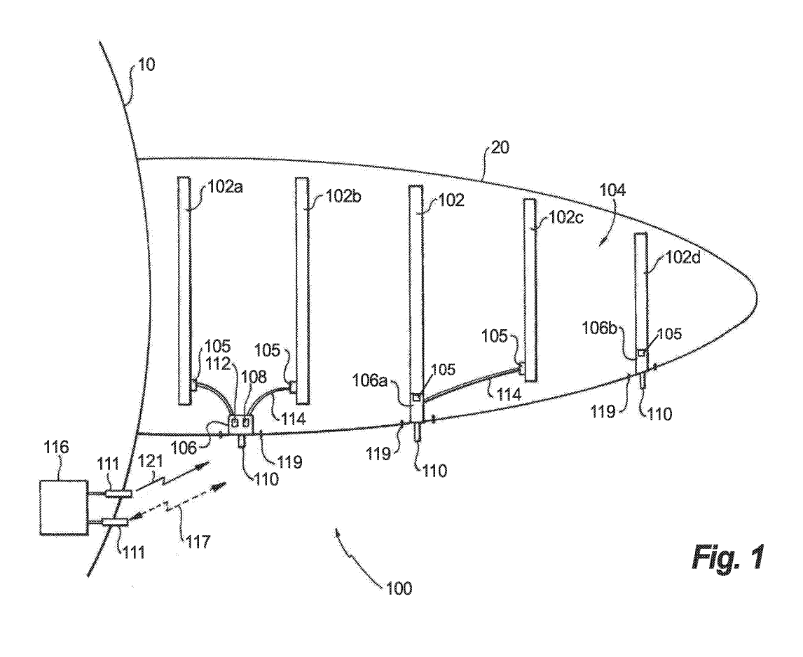

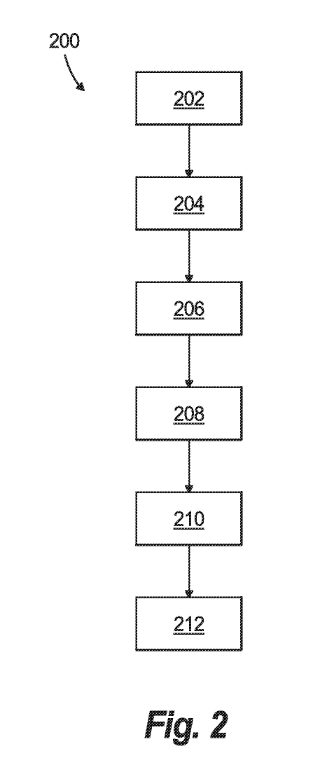

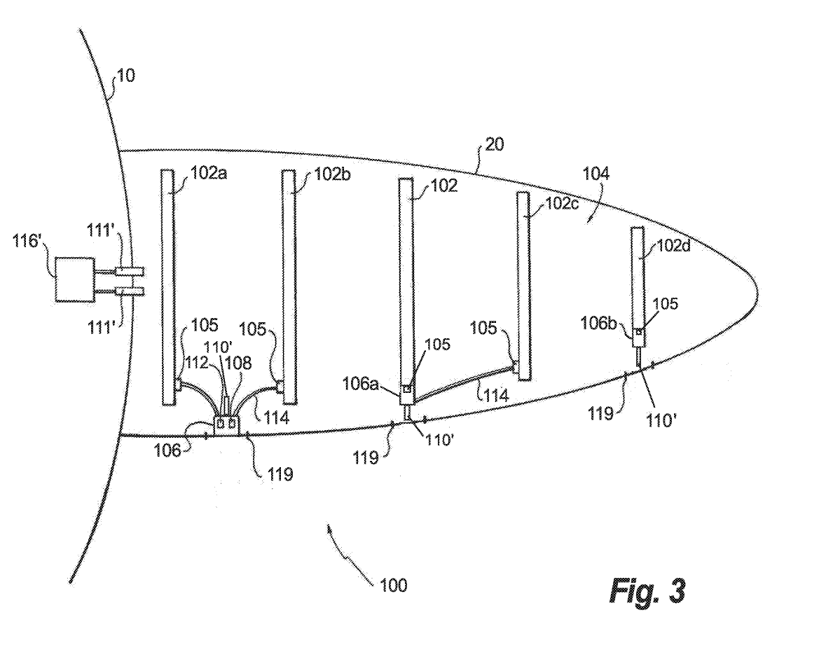

Reference will now be made to the drawings wherein like reference numerals identify similar structural features or aspects of the subject disclosure. For purposes of explanation and illustration, and not limitation, a schematic depiction of an exemplary embodiment of a sensor system in accordance with the disclosure is shown in FIG. 1 and is designated generally by reference character 100. Other embodiments of liquid level detection systems in accordance with the disclosure, or aspects thereof, are provided in FIGS. 2-3, as will be described. Embodiments of the present invention use wireless radio-frequency (RF) signals, instead of traditional wire harnesses, to remove means by which an electrical fault or external condition like lightning could couple onto electrical conductors, e.g. those found in traditional wire harness systems.

As shown in FIG. 1, a sensor system 100 is shown on a wing 20 of an aircraft 10. System 100 includes sensors 102 at least partially disposed in a liquid storage vessel 104 and exposed to a liquid. In some embodiments, sensors may not need to be disposed within liquid storage vessel, e.g. they might only need to be operatively connected to the outside of liquid storage vessel. Liquid storage vessel 104 is within wing 20. It is contemplated that sensors 102 can include an inductance sensor, e.g. a densitometer, a resistance sensor, e.g. a temperature sensor, or a capacitance sensor, e.g. a fluid height sensor, a dielectric properties sensor, or a conductivity sensor. Where sensors 102 are fluid height sensors, they can be capacitive based height sensors placed strategically throughout the vessel 104, dependent on vessel geometry. The fluid heights measured at each location, in conjunction with other fuel characteristics (such as density) can be used together to determine the overall quantity of fuel in vessel 104 by weight. It is also contemplated that the fuel dielectric can be used to adjust height, and fuel conductivity can be used to determine levels of fuel contamination.

With continued reference to FIG. 1, an electronics unit 106 is operatively connected to each sensor 102. In accordance with some embodiments, electronics unit 106 is remote from and connected through an optical cable 114 to a plurality of sensors, e.g. as shown with sensors 102a and 102b. Optical cable 114 connects electronics unit 106 to sensors 102a and 102b to transmit electrical excitation to sensors 102a and 102b and data from sensors 102a and 102b to electronics unit 106. System 100 can include an excitation module 105 operatively connected to each of sensors 102a and 102b between sensors 102a and 102b and optical cable 114. Excitation module 105 is the primary source of RF energy and communication with associated system equipment, e.g. electronics unit 106. Just as electronics unit 106 can be standalone or actually integrated with sensors 102, excitation module 105 can similarly be integrated with electronics unit 106, e.g. as shown in electronics units 106a and 106b.

In accordance with another embodiment, electronics unit 106 is directly connected to a respective one of sensors 102 as a module, for example, such as sensors 102 and 102d and their respective electronics units 106a and 106b. It is contemplated that more than one of the sensor-electronics unit arrangements described above can be used in the same system 100. Electronics unit 106, and/or sensor 102 with electronics unit 106 can be directly attached as a module are located on the aircraft skin, for example, close to an access door 119, eliminating or reducing the need for entry into vessel 104 to facilitate maintenance.

With continued reference to FIG. 1, each electronics unit 106 includes a power source 108 for providing power to sensor 102. System 100 includes antennas 110 operatively connected to each electronics unit 106 to receive data there from and to provide power to each of power sources 108. Power source 108 includes a battery 112 operatively connected to antenna 110 to store power received from antenna 110. Antennas 110 are at least partially outside of liquid vessel 104 in order to effectively transmit and receive RF signals. While system 100 is shown with a plurality of antennas 110, it is contemplated that a single antenna 110 can be used for all sensors 102, e.g. similar to the arrangement between sensors 102a and 102b.

Antennas 110 are wirelessly connected to a remote processing unit 116, e.g. a signal conditioner. Remote processing unit 116 is located in the fuselage of aircraft 10. Antennas 110 transmit data through RF signals to remote processing unit 116, shown schematically by the double headed arrow 117, and receive power, in the form of RF signals, shown schematically by the single headed arrow 119, from remote processing unit 116. Remote processing unit 116 is operatively connected to additional antennas 111 for transmitting and receiving wireless RF signals to and from antenna 110 of liquid storage vessel 104. It is contemplated that transmit/receive antennas 111 can be within unit 116, external to unit 116 and installed on the exterior skin of aircraft 10.

In accordance with another embodiment, as shown in FIG. 3, a remote processing unit 116′ is located in the fuselage of aircraft 10 such that additional antennas 111′ directly penetrate liquid storage vessel 104. Antennas 111′ and processing unit 116′ are similar to antennas 111 and processing unit 116, described above and shown in FIG. 1. Where antennas 111′ penetrate directly into liquid storage vessel 104, it is contemplated that antennas 110′ can be used. Antennas 110′ are similar to antennas 110, except that antennas 110′ do not penetrate outside of liquid storage vessel 104. The method described below can be used with the embodiments shown in FIG. 1 or 3.

As shown in FIG. 2, a method 200 for sensing characteristics of a liquid in a liquid storage vessel, e.g. liquid storage vessel 104, includes providing electrical power to an electronics unit, e.g. at least one of electronics units 106, through an antenna, e.g. at least one of antennas 110 or 110′, as shown by box 202. In this embodiment, a remote processing unit, e.g. a signal conditioner or remote processing unit 116 or 116′, transmits RF energy to the antenna that is operatively connected to the electronics unit located on or within the vessel. It is contemplated that method 200 includes storing power received from the antenna in a battery, e.g. battery 112, in the electronics unit, as indicated by box 204. Method 200 includes transmitting power from the electronics unit to the sensor, as indicated schematically by box 206. Electronics unit and/or battery are configured to store sufficient RF energy to enable acquisition of the fluid characteristic with the sensor and RF transmission of the information back to the processing unit. In accordance with some embodiments, transmitting power from the electronics unit to the sensor power includes transmitting the power with an optical cable, e.g. optical cable 114. Method 200 includes reading at least one of a height sensor, a temperature sensor or a density sensor, e.g. at least one of sensors 102, with the electronics unit, as indicated schematically by box 208. In accordance with some embodiments, reading the sensors includes transmitting data through the optical cable to the electronics unit.

With continued reference to FIG. 2, method 200 includes wirelessly transmitting data from the electronics unit to a remote processing unit, e.g. remote processing unit 116, with the antenna, as indicated schematically by box 210. Transmitting and receiving wireless signals to and from the antenna includes transmitting and receiving wireless signals to and from an additional antenna, e.g. antenna 111 or 111′, operatively connected to the remote processing unit. Method 200 includes sensing a characteristic of liquid in the liquid storage vessel based on the data transmitted to the remote processing unit, as indicated by box 212, for example, determining a liquid level in the liquid storage vessel.

The methods and systems of the present disclosure, as described above and shown in the drawings, provide for sensor systems and methods with superior properties including electrical isolation, reduced power requirement and ease of installation. While the apparatus and methods of the subject disclosure have been shown and described with reference to preferred embodiments, those skilled in the art will readily appreciate that changes and/or modifications may be made thereto without departing from the spirit and scope of the subject disclosure.

What is claimed is:

1. A sensor system comprising:
a sensor operatively connected to a liquid storage vessel;
an electronics unit operatively connected to the sensor, wherein the electronics unit includes a power source for providing electrical excitation to the sensor; and
an antenna operatively connected to the electronics unit to receive data there from and to provide power to the power source, wherein the antenna is wirelessly connected to a remote processing unit to transmit data thereto and to receive power there from.

2. The sensor system as recited in claim 1, wherein the sensor is at least partially disposed in the liquid storage vessel and exposed to liquid.

3. The sensor system as recited in claim 1, wherein the sensor is at least one of an inductance sensor, a resistance sensor, or a capacitance sensor.

4. The sensor system as recited in claim 1, wherein the sensor is one of a plurality of sensors, wherein the plurality of sensors include at least one of an inductance sensor, a resistance sensor, or a capacitance sensor.

5. The sensor system as recited in claim 1, wherein the remote processing unit is operatively connected to one or more additional antennas configured to transmit and receive wireless signals to and from the antenna at least partially disposed outside of the liquid storage vessel.

6. The sensor system as recited in claim 1, further comprising an optical cable connecting the electronics unit to the sensor to transmit power to the sensor and data from the sensor to the electronics unit.

7. The sensor system as recited in claim 1, wherein the antenna is configured to be at least partially outside of the liquid storage vessel.

8. The sensor system as recited in claim 1, wherein the power source includes a battery operatively connected to the antenna to store power received from the antenna.

9. A method for sensing characteristics of a liquid comprising:
providing electrical power to an electronics unit through an antenna, wherein the electronics unit is operatively connected to a sensor;
transmitting data from the sensor to the electronics unit; and
wirelessly transmitting the data from the electronics unit to a remote processing unit with the antenna, wherein the antenna is at least partially disposed outside of a liquid storage vessel.

10. The method as recited in claim 9, wherein the data includes at least one of a height, a density, or a temperature of the liquid.

11. The method as recited in claim 9, further comprising determining a quantity of liquid in the liquid storage vessel based on the data transmitted to the remote processing unit.

12. The method as recited in claim 9, wherein the sensor is one of a plurality of sensors in a sensor network, wherein the sensor network includes at least one of a height sensor, a densitometer, or a temperature sensor.

13. The method as recited in claim 9, further comprising transmitting and receiving wireless signals to and from the antenna with at least one additional antenna operatively connected to the remote processing unit.

14. The method as recited in claim 9, further comprising transmitting electrical excitation with an optical cable from the electronics unit to the sensor.

15. The method as recited in claim 9, further comprising storing power received from the antenna in a battery in the electronics unit.
